(19) United States
(12) Patent Application Publication
(10) Pub. No.: US 2007/0154003 A1
(43) Pub. Date: Jul. 5, 2007

(54) Subscriber line common mode slew rate control

(76) Inventors: Ion C. Tesu, Austin, TX (US); Marius Goldenberg, Austin, TX (US)

Correspondence Address: DAVIS & ASSOCIATES, P.O. BOX 1093, DRIPPING SPRINGS, TX, 78620, US

(21) Appl. No.: 11/324,182

(22) Filed: Dec. 31, 2005

(51) Int. Cl. H04M 3/42

(52) U.S. Cl. 379/207.07; 379/207.06

(57) ABSTRACT

A subscriber line interface circuit apparatus includes indicating circuitry indicating a change between a first state and a second state of subscriber equipment coupled to a subscriber line. Common mode control circuitry transitions a common mode variable of the subscriber line from a first value to a distinct second value, wherein the transition is slew-rate limited. In one embodiment, a method includes ramping a common mode variable from a first value to a second value upon initiation of a state change of subscriber equipment coupled to a subscriber line.

### FIELD OF THE INVENTION

This invention relates to the field of telecommunications. In particular, this invention is drawn to subscriber line communications.

### BACKGROUND

The plain old telephone system (POTS) was initially architected to carry voice data in analog form from one subscriber to another via configurable switches. Although the telephone network evolved to using a digital transport network (i.e., the Public Switched Telephone Network (PSTN)), communication on the subscriber line connecting subscribers to the central office that serves as the entry point to the PSTN is predominately analog. The “last mile” between the subscriber and the central office was architected for analog communications in the voiceband frequency range. Digital communications were accomplished using modems operating within the voiceband communications spectrum.

Numerous communication protocol standards have since developed to enable using the POTS infrastructure for communicating digital data at higher data rates by utilizing a communication bandwidth greater than that of the voiceband. Protocols (xDSL) for digital subscriber line services typically limit their communication spectrum to a range that is not used for voiceband communications. As a result, xDSL services may co-exist with voiceband communications on the same subscriber line.

Voiceband communications between subscriber equipment and the central office is handled by a central office subscriber line interface circuit (SLIC). POTS equipment engages in a signaling protocol to establish communications between voiceband equipment. The signaling can generate spectral components extraneous to the voiceband communications spectrum. Changing between on-hook and off-hook states is one example of such signaling. When utilizing a shared subscriber line, the extraneous spectral components can interfere with xDSL services. The amount of interference, for example, can result in a reduced data rate for the xDSL services. If the interference is large enough, disruption or termination of the xDSL services may result.

### SUMMARY

One method includes ramping a common mode variable from a first value to a second value upon initiation of a state change of subscriber equipment coupled to a subscriber line.

Another method includes detecting a change between an on-hook state and an off-hook state of subscriber equipment coupled to a subscriber line. A selected common mode variable of the subscriber line is transitioned from a first value to a distinct second value, wherein the transition is slew-rate limited.

Another method includes changing between a non-ringing state and a ringing state for subscriber equipment coupled to a subscriber line. A selected common mode variable of the subscriber line is transitioned from a first value to a distinct second value, wherein the transition is slew-rate limited.

A subscriber line interface circuit apparatus includes indicating circuitry indicating a change between a first state and a second state of subscriber equipment coupled to a subscriber line. The apparatus includes common mode control circuitry that transitions a common mode variable of the subscriber line from a first value to a distinct second value in response to the indicated change, wherein the transition is slew-rate limited.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a communications network architecture supporting xDSL and POTS communications.

FIG. 2 illustrates one embodiment of a communication spectrum allocation for a subscriber line.

FIG. 3 illustrates one embodiment of a method of controlling a subscriber line common mode variable.

FIG. 4 illustrates one embodiment of subscriber line waveforms.

FIG. 5 illustrates one embodiment of providing a transition from a first value to a distinct second value of a common mode variable.

FIG. 6 illustrates one embodiment of another method of controlling a subscriber line common mode variable.

FIG. 7 illustrates one embodiment of subscriber line waveforms.

FIG. 8 illustrates one embodiment of another method of controlling a subscriber line common mode variable.

FIG. 9 illustrates one embodiment of a SLIC.

### DETAILED DESCRIPTION

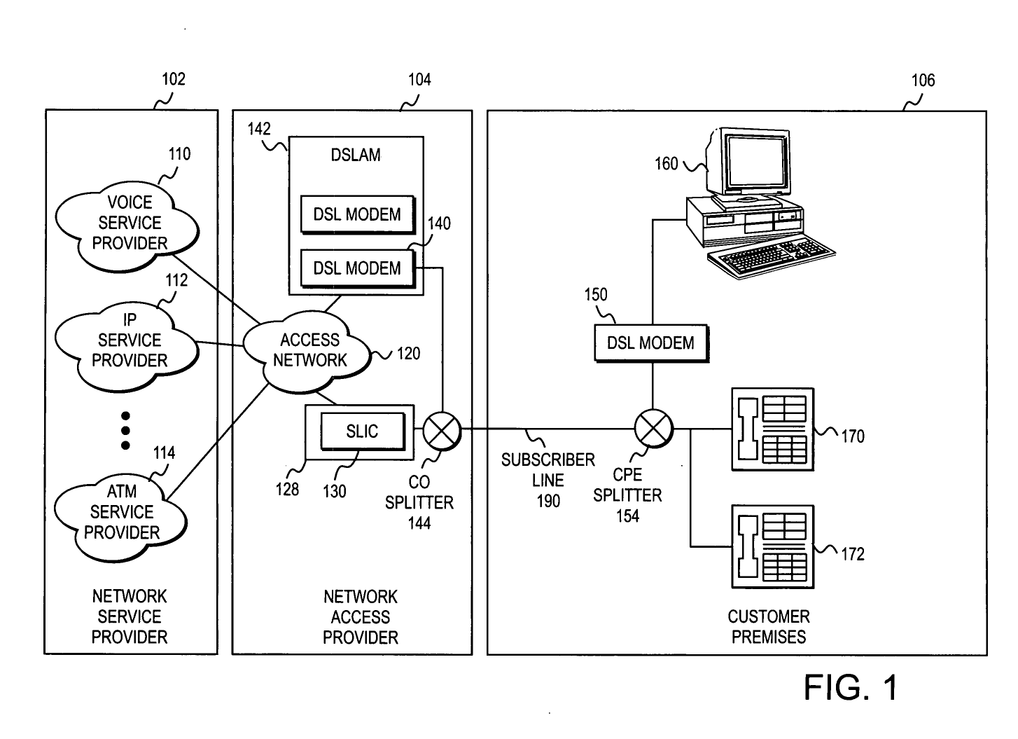

FIG. 1 illustrates an embodiment of a communications network model supporting voice and digital services (e.g., xDSL) on a common subscriber line 190. The network model is divided into three physical domains: network service provider(s) 102, network access providers 104, and customer premises 106.

The network service providers (NSP) may have networks that span large geographic areas. Typically, however, the customer premises (CP) must be located within a specified distance of the network access provider (NAP) as a result of electrical specifications on the subscriber line 190. Thus network access providers typically have a number of central offices (CO) that support customers within a specified radius. Local exchange carriers (LEC) and competitive local exchange carriers (CLEC) are examples of network access providers.

In one embodiment, the network access provider is a telephone company. Subscriber equipment (i.e., customer premises equipment such as telephones 170, 172) is connected to a central office (CO) of the network access provider 104 via a subscriber line 190. For plain old telephone systems (POTS), the subscriber line includes a tip line and a ring line that are typically implemented as an unshielded twisted copper wire pair. The tip line, ring line, and subscriber equipment form a subscriber loop.

The central office has numerous POTS linecards 128 for supporting multiple subscriber lines. Each linecard has at least one subscriber line interface circuit (SLIC) 130 that serves as an interface between a digital switching access network 120 of a local telephone company central office and the subscriber equipment 170, 172. The SLIC is expected to perform a number of functions often collectively referred to as the BORSCHT requirements. BORSCHT is an acronym for “battery feed,” “overvoltage protection,” “ring,” “supervision,” “codec,” “hybrid,” and “test” (e.g., loop diagnostics). The NAP access network 120 couples the POTS linecard to a voice provider network 110 such as the public switched telephone network (PSTN) for bi-directional communication with other subscribers similarly coupled to the voice provider network.

Historically, the network access providers served to connect customers or subscribers to the PSTN for voiceband communications (communications having an analog bandwidth of approximately 4 kHz or less). Although the PSTN is digital in nature, the connection (subscriber line 190) between the customer premises 106 and the network access provider 104 is analog.

The subscriber line may be provisioned for additional services by using communication channels outside the voiceband. Thus, for example, digital subscriber line services may simultaneously co-exist with voiceband communications by using channels other than the voiceband. The choice of frequency ranges and line codes for these additional services is the subject of various standards. The International Telecommunication Union (ITU), for example, has set forth a series of recommendations for subscriber line data transmission. These recommendations are directed towards communications using the voiceband portion of the communications spectrum (“V.x” recommendations) as well as communications utilizing frequency spectrum other than the voiceband portion (e.g., “xDSL” recommendations). Various examples of line code standards include quadrature amplitude and phase modulation, discrete multi-tone modulation, carrierless amplitude phase modulation, and two binary one quaternary (2B1Q).

Asymmetric digital subscriber line (ADSL) communications represent one variant of xDSL communications. Exemplary ADSL specifications are set forth in “Rec. G.992.1 (06/99)—Asymmetric digital subscriber line (ADSL) transceivers” (also referred to as full rate ADSL), and “Rec. G.992.2 (06/99)—Splitterless asymmetric digital subscriber line (ADSL) transceivers” (also referred to as G.LITE).

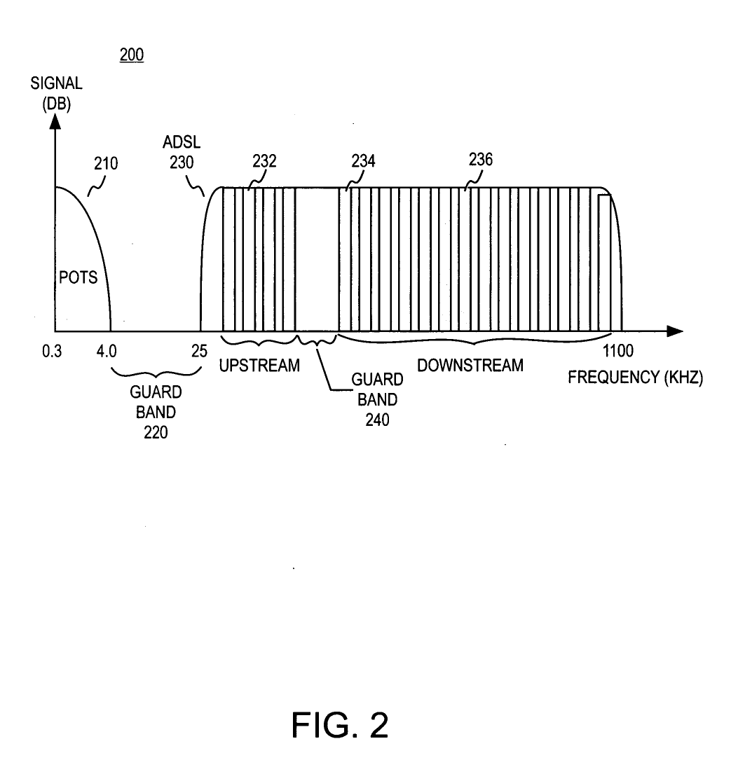

FIG. 2 illustrates one embodiment of communication spectrum allocation for a subscriber line. Chart 200 compares the portions of the spectrum used for voiceband applications (POTS 210) as well as digital services (e.g., ADSL 230). POTS communications typically use the voiceband range of 300-4000 Hz. One xDSL variant uses frequencies beyond the voiceband in the range of approximately 25-1100 kHz as indicated. A guard band 220 separates the POTS and ADSL ranges.

There are multiple line coding variations for xDSL. Carrierless Amplitude Phase (CAP) modulation and Discrete Multi-Tone (DMT) modulation both use the fundamental techniques of quadrature amplitude modulation (QAM). CAP is a single carrier protocol where the carrier is suppressed before transmission and reconstructed at the receiving end. DMT is a multicarrier protocol. FIG. 2 illustrates DMT line coding.

DMT modulation has been established as a standard line code for ADSL communication. For full-rate ADSL the available bandwidth is divided into 256 sub-channels. The available bandwidth and the number of sub-channels varies with ADSL variants. G.Lite, for example, has a 552 Khz upper channel boundary. ADSL2+ has an upper channel boundary of 2.2 MHz, effectively doubling the available bandwidth and the number of sub-channels with respect to full-rate ADSL.

Each sub-channel 234 is associated with a carrier. The carriers (also referred to as tones) are spaced 4.3125 KHz apart. Each sub-channel is modulated using quadrature amplitude modulation (QAM) and can carry 0-15 bits/Hz. The actual number of bits is allocated depending upon line conditions. Thus individual sub-channels may be carrying different numbers of bits/Hz. Some sub-channels 236 might not be used at all.

In one embodiment, ADSL uses some sub-channels 234 for downstream communication and other sub-channels 232 for upstream communication (i.e., frequency division multiplexed (FDM) ADSL). The upstream and downstream sub-channels may be separated by another guard band 240. ADSL is named for the asymmetry in bandwidth allocated to upstream compared to the bandwidth allocated to downstream communication.

During initialization the signal-to-noise ratio of each DMT sub-channel is measured to determine an appropriate data rate assignment. Generally, greater data rates (i.e., more bits/Hz) are assigned to the lower sub-channels because signals are attenuated more at higher frequencies. DMT implementations may also incorporate rate adaption to monitor the line conditions and dynamically change the data rate for sub-channels.

xDSL can be provisioned using the same subscriber line as that used for standard POTS communications thus leveraging existing infrastructure. The availability of xDSL technology permits delivery of additional services to the subscriber.

Referring to FIG. 1, a digital subscriber line access multiplexer (DSLAM) 142 has a plurality of DSL linecards with DSL modems 140. These modems are also referred to as ATU-C (central office ADSL Transceiver Unit) for ADSL applications. The access network 120 enables communication with digital network service providers such as Internet protocol (IP) service providers 112 and asynchronous transfer mode (ATM) service providers 114. A DSLAM modem linecard provides a connection from one of the digital networks via access network 120 to the subscriber line 190 through the use of a central office splitter 144.

The splitter 144 serves to filter the appropriate portion of the subscriber line 190 communications for both the DSL modem linecard 140 and the POTS linecard 128. In particular, the splitter eliminates the xDSL portion of the subscriber line communications for the POTS linecard 128. The splitter eliminates the voiceband communications for the DSL modem linecard 140. The splitter also protects the DSL modem linecard from the large transients and control signals associated with the POTS communications on the subscriber line.

The CO splitter thus effectively splits upstream communications from the subscriber equipment into at least two spectral ranges: voiceband and non-voiceband. The upstream voiceband range is provided to the POTS linecard and the upstream non-voiceband range is provided to the DSL modem linecard. The splitter couples the distinctly originating downstream voiceband and downstream non-voiceband communications to a common physical subscriber line 190.

A customer premises equipment splitter 154 may also be required at the customer premises for the POTS subscriber equipment 170, 172. The CPE splitter 154 passes only the voiceband portion of the subscriber line communications to the POTS subscriber equipment.

In one embodiment, the CPE splitter provides the DSL communications to a DSL modem 150 that serves as a communications interface for digital subscriber equipment such as computer 160. DSL modem 150 may also be referred to as an ATU-R (remote ADSL transceiver unit) for ADSL applications.

The DSL service overlays the existing POTS service on the same subscriber line. This solution avoids the capital costs of placing dedicated digital subscriber lines and permits utilizing existing POTS linecards.

State changes by the POTS equipment routinely involve changes in voltage or current levels. For example, the current in the subscriber loop due to POTS equipment may be insignificant when the POTS subscriber equipment is on-hook. The individual tip and ring line voltages are of little consequence when the POTS subscriber equipment is on-hook. Once the POTS subscriber equipment changes to an off-hook state, however, a non-negligible subscriber loop current exists. In order to reduce the power dissipated by the POTS subscriber equipment, the SLIC may adjust the battery feed to provide a lower nominal value.

The individual tip and ring line voltages and the loop current determine the amount of power dissipated by the driving elements of a SLIC linefeed driver when providing battery feed for the POTS equipment. Signaling and communications, however, generally rely only on the difference between the tip and ring. The common mode voltage may be changed in order to adjust the amount of power dissipated without disturbing the differential mode voltage.

An opportunity for power savings occurs when changing from an on-hook to an off-hook state because the battery feed is reduced. Although the same opportunity for power savings is not present when changing from a non-ringing to a ringing state (because of the increased power dissipation), the common mode voltage in both cases is transitioned to a level (e.g., approximately one-half of the battery feed) that ensures substantially equal power dissipation by the driving elements of the SLIC linefeed driver 916.

Ideally, the common mode and differential mode variables are orthogonal such that changes to common mode variables (e.g., common mode current or common mode voltage) do not affect any differential mode signals. If each of the tip and ring lines are adjusted by the same value, the difference between the tip and ring should remain constant. In practice, however, the common mode and differential mode variables may be coupled due to imperfect matching between the lines or between counterpart components coupled to the lines. As a result, changes to common mode variables may appear in the subscriber line differential mode signal.

Changes in the common mode variable generate extraneous spectral components that extend into the xDSL communication spectrum. Given that a proportion of the energy associated with the spectral components can appear in the differential mode signal, the signal-to-noise ratio of the DMT sub-channels will be decreased. This results in a decrease in data rate if the signal-to-noise ratio renders some of the lower sub-channels completely or partially unusable. The lower sub-channels have the higher data rate assignments and disruption has a significant detrimental effect on the overall xDSL data rate as a result. Abrupt changes in the common mode variables for the purpose of achieving power savings can thus have a deleterious affect on xDSL services.

A subscriber line state change from on-hook to off-hook, for example, can generate sufficient noise to require a time consuming retraining and re-acquisition of a link between the central office and customer premises xDSL equipment. Changes to common mode variables during this time period can generate sufficient noise to extend the time required for retraining and re-acquisition of xDSL services. Changes to common mode variables after this time period can cause the xDSL equipment to initiate yet another retraining and re-acquisition cycle.

In order to avoid or minimize disruption of the xDSL services, transitions in the common mode variable are slew-rate limited. In particular, transitions from a first value to a distinct second value are conducted in a manner such that the transition in the variable over time does not exceed a pre-determined threshold.

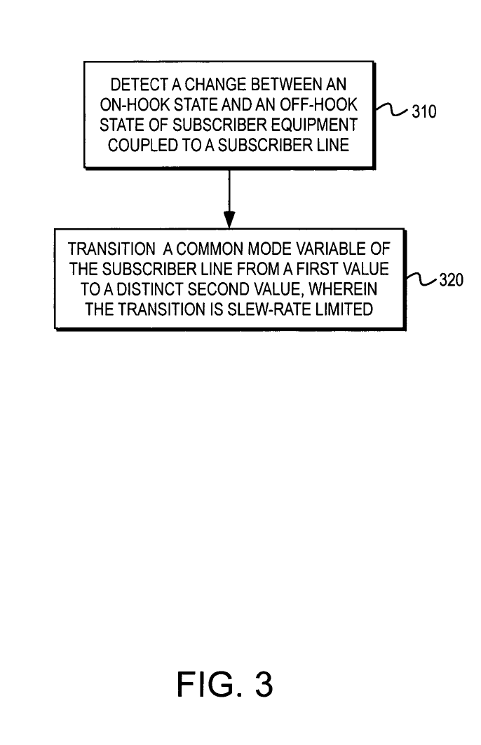

FIG. 3 illustrates one embodiment of a method of operating POTS equipment. A change between an on-hook state and an off-hook state of subscriber equipment coupled to a subscriber line is detected in step 310. A common mode variable of the subscriber line is transitioned from a first value to a distinct second value in step 320. The transition is slew-rate limited.

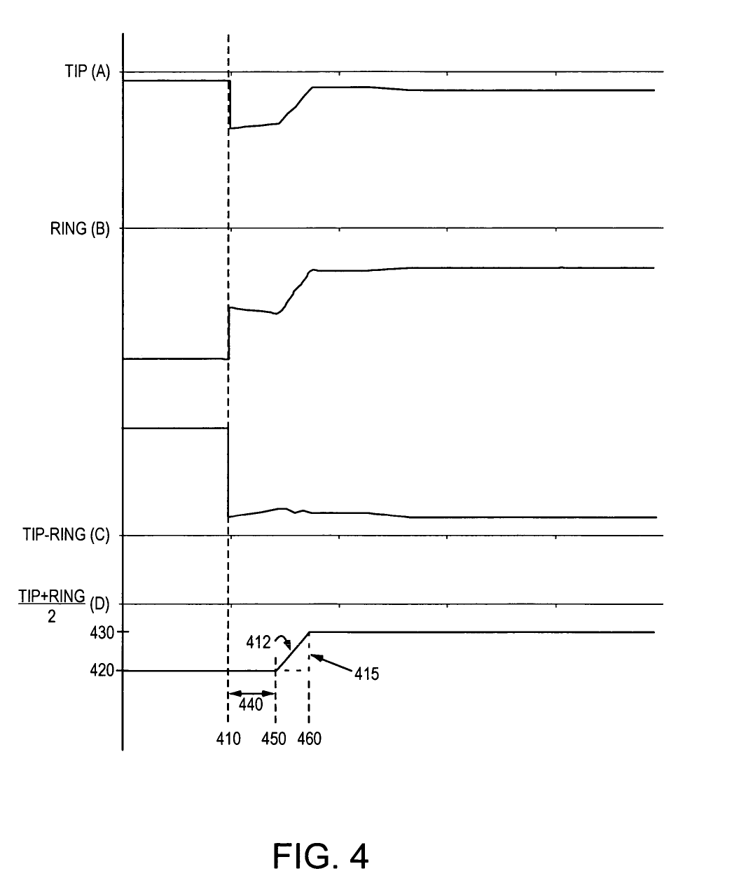

FIG. 4 illustrates a plurality of subscriber line waveforms. The individual tip and ring voltages are illustrated as waveforms (a) and (b), respectively.

The change in tip and ring voltages at point 410 indicates that the POTS equipment has changed from an on-hook state to an off-hook state. Some elapsed time period 440 after the state change, the common mode voltage (d) is increased beginning at time 450 to equalize the power dissipated among driving elements of the SLIC linefeed driver and to reduce the power consumed by the SLIC. The common mode voltage may similarly be reduced when the POTS equipment changes from the off-hook state back to the on-hook state. Changes to the common mode voltage are reflected in corresponding changes in the tip (a) and ring (b) voltages. Ideally, the differential voltage (c) is substantially unaffected by the common mode voltage (d).

In order to minimize or decrease the disturbance to the xDSL equipment, transitions in the common mode variable are deliberately slew-rate limited as indicated by transition 412. At time 450, instead of an abrupt transition as indicated by dotted waveform portion 415, the transition from a first value 420 to a second value 430 is controlled to introduce a slope into the waveform. The change (ΔCM) in the common mode variable is distributed over the time frame, ΔT. The rate of change from the first value to the second value is defined by the slope of 412 (i.e., slew-rate=ΔCM/ΔT). Transition 412 is a rising transition. A complementary falling transition is appropriate when changing from off-hook to the on-hook state.

The slew-rate may be consistent throughout the transition as indicated by FIG. 4. In particular, the transition may have a substantially consistent slope throughout (i.e., a pure ramp) in which case the derivative dCM/dt is substantially constant over the ΔT interval from 450 to 460 such that

$$\frac{ⅆ CM}{ⅆ t} {\vert}_{450}^{460} = \frac{Δ CM}{Δ T}$$

In another embodiment, the transition may be achieved as a series of steps. Both approaches entail ramping the common mode variable. The first approach may be referred to as a substantially pure ramp. The latter approach may be referred to as a stepped-ramp. The stepped-ramp approaches the substantially pure ramp as the number of steps increases. In one embodiment, the common mode control circuitry is digital in nature and the stepped-ramp is the preferred solution.

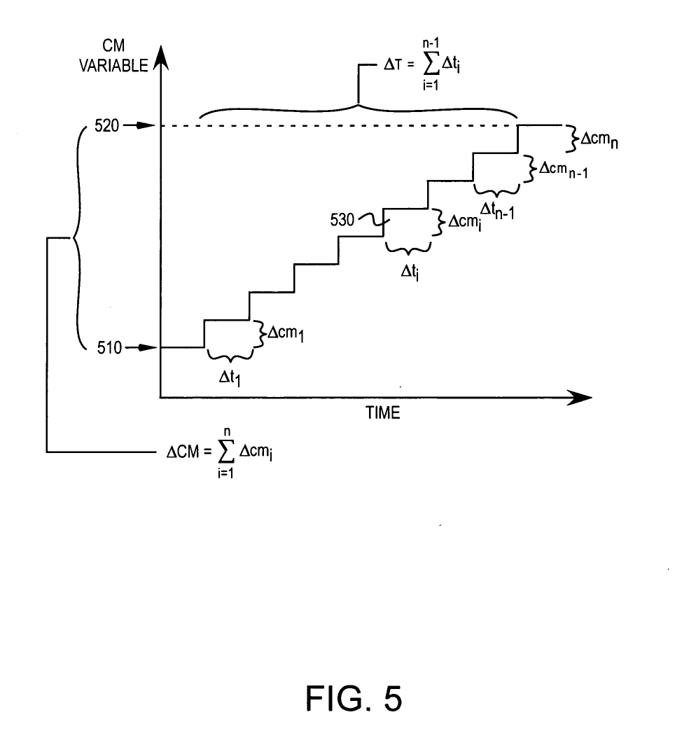

FIG. 5 illustrates ramping of a common mode variable from a first value 510 to a second value 520 using a plurality of steps 530. This approach contrasts with transitioning from the first value to the second value in a single large step ΔCM over a shorter time frame. The incremental changes Δcmᵢ to the common mode variable accumulate such that:

$$Δ CM = {\sum }_{i = 1}^{n} Δ c {m}_{i}$$

Similarly, each change in the common mode variable is separated by a time interval, Δtᵢ such that:

$$Δ T = {\sum }_{i = 1}^{n - 1} Δ {t}_{i}$$

Although each of the smaller steps 530 contributes to the extraneous spectral components, the amount of energy associated with each step is much smaller than the energy associated with the single large step. In addition, the steps are time displaced (Δtᵢ) such that the energy of extraneous components cannot accumulate in the xDSL communication band. Thus although the total amount of energy associated with the extraneous spectral components might be the same between the single large step and the plurality of smaller steps, the slew has the effect of spreading the energy generated by the smaller steps over a period of time.

The time intervals may be chosen sufficiently long enough to permit some dissipation of the disturbance resulting from the step transition in the common mode variable. In one embodiment, the time intervals are substantially the same (i.e., Δtᵢ=Δtⱼ,∀i,jε{1, . . . n−1}).

Similarly, the change in the common mode variable (e.g., voltage) should be small enough to avoid disrupting xDSL services at each step. In one embodiment, the change in the common mode variable is substantially the same for each step (i.e., Δcmᵢ=Δcmⱼ,∀i,jε{1, . . . n}).

In the illustrated embodiment, the stepped transition from the first value to the second value is a monotonic transition. Thus the transitions may be monotonically ramped.

Another example of a POTS subscriber equipment state change that can be problematic for xDSL equipment is the change between ringing and not ringing. Determination of the state change is simplified given that the SLIC is handling the ringing function.

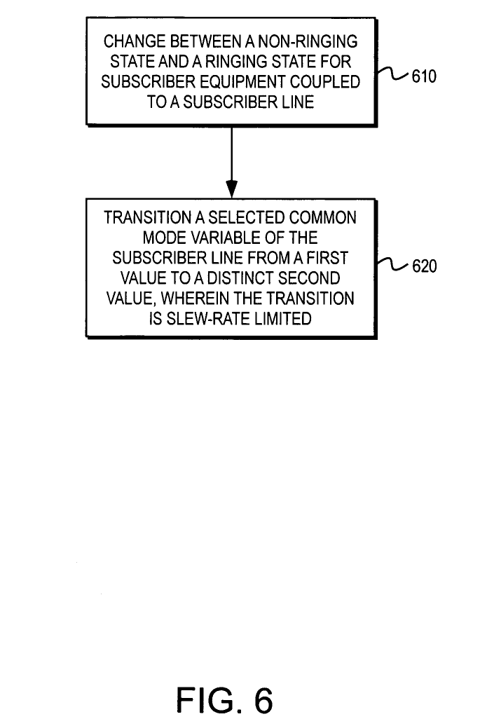

FIG. 6 illustrates one embodiment of a method of controlling a subscriber line common mode variable. A change between a non-ringing state and a ringing state for subscriber equipment coupled to a subscriber line occurs in step 610. A selected common mode variable is transitioned from a first value to a distinct second value in step 620. The transition is slew rate limited. In one embodiment, transition of the common mode variable is initiated at the same time as or shortly after the state change.

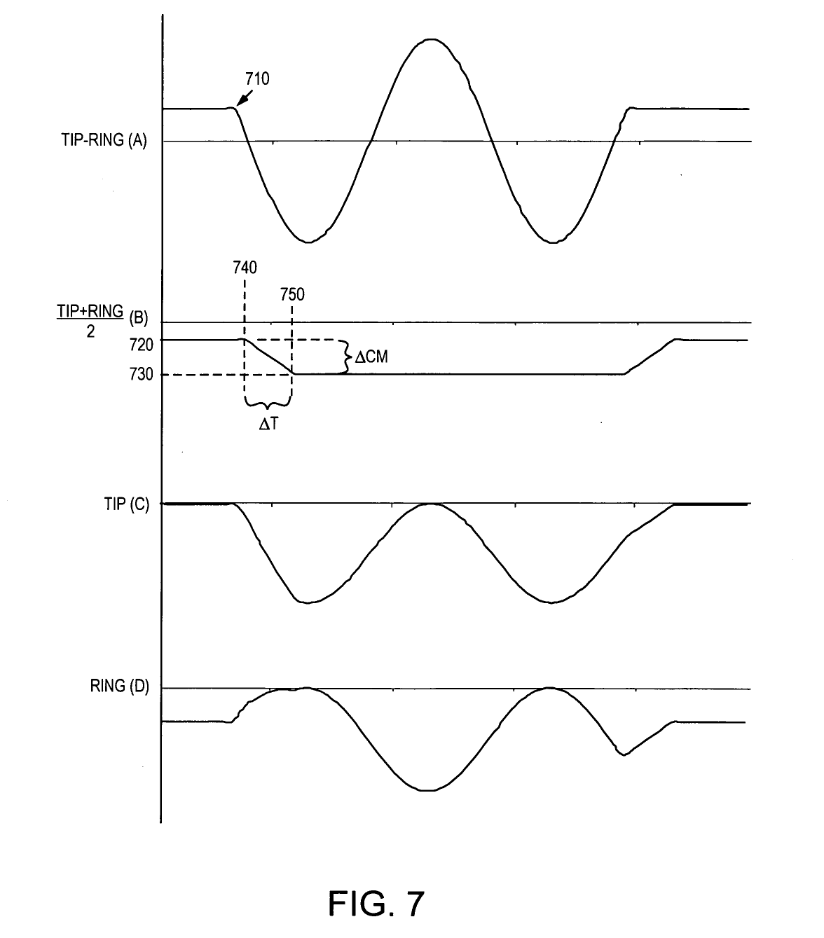

FIG. 7 illustrates subscriber line waveforms resulting from the application of the method of FIG. 6. The differential (TIP-RING) ringing signal is illustrated as waveform (a). Waveform (b) represents the common mode voltage applied to each of the tip and ring. Waveform (c) is the tip signal. Waveform (d) is the ring signal.

The SLIC changes from non-ringing to ringing at point 710. Ringing requires more power than either the on-hook or off-hook states, however, the common mode voltage is transitioned from a first value 720 to a second value 730 in order to improve distribution of the power dissipation among the driving elements of the linefeed driver.

Instead of transitioning in a single step, however, the common mode voltage transition is slewed to create a sloped transition. The slew may be created using a plurality of steps such as those illustrated in FIG. 5 (i.e., a stepped ramp). Alternatively, the transition may have a substantially consistent slope throughout (i.e., a pure ramp) in which case the derivative dCM/dt is substantially constant over the ΔT interval from 740 to 750 such that

$$\frac{ⅆ C M}{ⅆ t} {\vert}_{740}^{750} = \frac{Δ CM}{Δ T}$$

The transition in the common mode voltage is deliberately slew rate limited to ameliorate the disruptive effect that a large step could otherwise have in the xDSL spectrum.

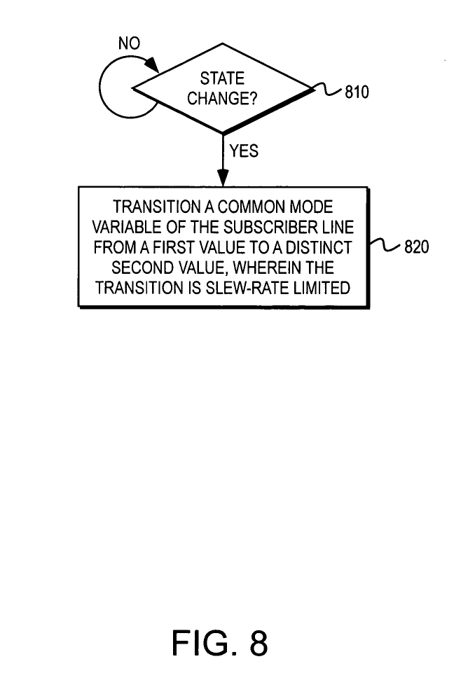

FIG. 8 illustrates another embodiment of a method of controlling a common mode variable of a subscriber line. Step 810 determines if a state change has occurred. If a state change has occurred, a common mode variable of the subscriber line is transitioned from a first value to a distinct second value in step 820. The transition is slew-rate limited.

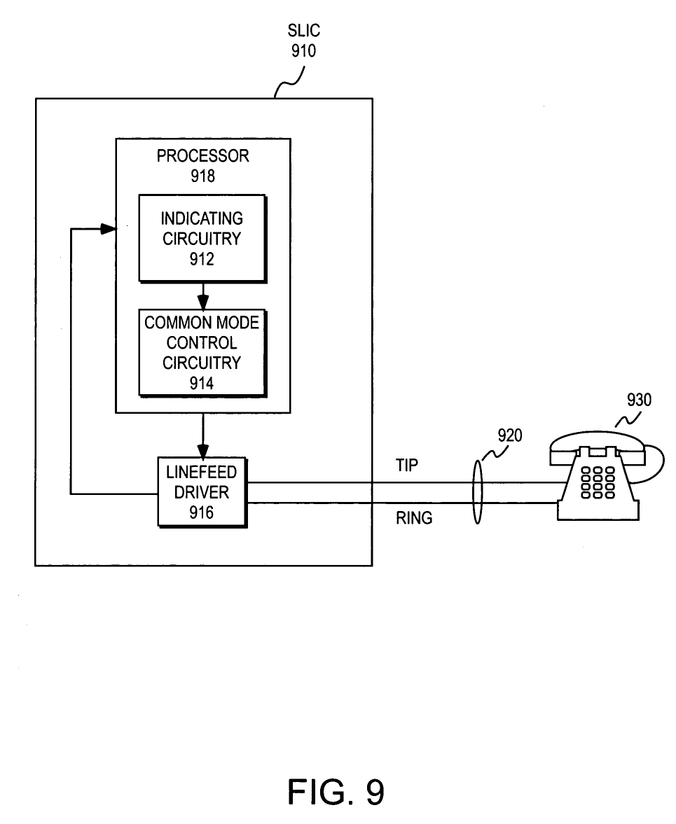

FIG. 9 illustrates one embodiment of a SLIC 910 coupled to subscriber equipment 930 via a subscriber line 920. Circuitry related to xDSL services is omitted from FIG. 9. If xDSL services are present, however, subscriber line 920 may be carrying DMT modulated signals.

The SLIC includes indicating circuitry 912 to indicate a change of state of the subscriber equipment. In one embodiment, the indicating circuitry is implemented by a processor 918. The processor controls a linefeed driver 916 which provides battery feed to the subscriber line 920 and subscriber equipment 930 in response to sensed subscriber line signals. In the illustrated embodiment, the linefeed driver provides the processor with the sensed subscriber line signals. The processor interprets these subscriber line signals to determine the appropriate control for the tip and ring lines for a given state or to interpret the state of the subscriber equipment.

State changes initiated by the SLIC such as changes between ringing and non-ringing are readily indicated by the indicating circuitry. Changes initiated by the subscriber equipment, however, require monitoring of the subscriber line. Changes between on-hook and off-hook, for example, are initiated by the subscriber equipment. Determination of the on-hook or off-hook state may be made programmatically by the processor. Generally, the indicator circuitry may be implemented programmatically by the processor for determining state change. The indicating circuitry indicates the state change regardless of whether the change is initiated by the SLIC or the subscriber equipment.

The SLIC also includes common mode control circuitry 914. The common mode control circuitry transitions a common mode variable of the subscriber line from a first value to a distinct second value in response to a change of state indicated by the indicating circuitry 912. The common mode control circuitry ensures that the transition is slew-rate limited. The common mode control circuitry may be implemented programmatically as a plurality of instructions executed by the processor.

The common mode variable controlled in the described apparatus and methods may include current and voltage. Although examples of transitioning the common mode variable have been discussed with respect to rising transitions and positive slopes, the falling transitions may be similarly slew-limited with a negative slope. Generally, the transition from the first value (V1) to the second value (V2) is slew-rate limited regardless of whether V1≧V2 or V2≧V1 such that

$$\frac{\vert Δ CM \vert}{Δ T} \leq K ,$$

where K is a pre-determined value. In one embodiment using a stepped ramp, Δcmᵢ=0.25 volts and Δtᵢ=8 μs, thus yielding K=31.250 volts/ms.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A method comprising:
detecting a change between an on-hook state and an off-hook state of subscriber equipment coupled to a subscriber line; and
transitioning a selected common mode variable of the subscriber line from a first value to a distinct second value, wherein the transition is slew-rate limited.

2. The method of claim 1 wherein the subscriber line is carrying a discrete multi-tone modulated signal.

3. The method of claim 1 wherein the selected common mode variable is voltage.

4. The method of claim 1 wherein the subscriber equipment communicates within a voiceband communication spectrum.

5. The method of claim 1 wherein the change is from the on-hook state to the off-hook state.

6. The method of claim 1 wherein the transitioning is performed in a plurality of steps.

7. The method of claim 1 wherein the transitioning is monotonic.

8. A method comprising:
changing between a non-ringing state and a ringing state for subscriber equipment coupled to a subscriber line; and
transitioning a selected common mode variable of the subscriber line from a first value to a distinct second value, wherein the transition is slew-rate limited.

9. The method of claim 8 wherein the subscriber line is carrying a discrete multi-tone modulated signal.

10. The method of claim 8 wherein the selected common mode variable is voltage.

11. The method of claim 8 wherein the subscriber equipment communicates within a voiceband communication spectrum.

12. The method of claim 8 wherein the change is from the non-ringing state to the ringing state.

13. The method of claim 8 wherein the transitioning is performed in a plurality of steps.

14. The method of claim 8 wherein the transitioning is monotonic.

15. A method comprising:
transitioning a common mode variable from a first value to a second value upon initiation of a state change of subscriber equipment coupled to a subscriber line, wherein the transition is slew-rate limited.

16. The method of claim 15 wherein the selected common mode variable is voltage.

17. The method of claim 15 wherein the change is from the non-ringing state to the ringing state.

18. The method of claim 15 wherein the change is from the off-hook state to the on-hook state.

19. The method of claim 15 wherein the transitioning is performed in a plurality of steps.

20. The method of claim 15 wherein the transitioning is monotonic.

21. A subscriber line interface circuit apparatus comprising:
indicating circuitry indicating a change between a first state and a second state of subscriber equipment coupled to a subscriber line; and
common mode control circuitry transitioning a common mode variable of the subscriber line from a first value to a distinct second value in response to the indicated change, wherein the transition is slew-rate limited.

22. The apparatus of claim 21 wherein the selected common mode variable is voltage.

23. The method of claim 21 wherein the change is from the non-ringing state to the ringing state.

24. The method of claim 21 wherein the change is from the off-hook state to the on-hook state.

25. The method of claim 21 wherein the transitioning is performed in a plurality of steps.

26. The method of claim 21 wherein the transitioning is monotonic.
